(19) United States
(12) Patent Application Publication
(10) Pub. No.: US 2014/0043310 A1
(43) Pub. Date: Feb. 13, 2014

(54) OPTICAL DETECTION SYSTEM

(71) Applicant: CHROMA ATE INC., Kuei-Shan Hsiang (TW)

(72) Inventors: Ding-Hsiang Pan, Kuei-Shan Hsiang (TW); Hsin-Yueh Sung, Kuei-Shan Hsiang (TW); Tsung-Hsien Ou, Kuei-Shan Hsiang (TW); Yu-Hsuan Lin, Kuei-Shan Hsiang (TW)

(73) Assignee: CHROMA ATE INC., Kuei-Shan Hsiang (TW)

(21) Appl. No.: 13/961,856

(22) Filed: Aug. 7, 2013

(30) Foreign Application Priority Data
Aug. 8, 2012 (TW) 101128598

(51) Int. Cl. G09G 5/10

(52) U.S. Cl. CPC G09G 5/10
USPC 345/207

(57) ABSTRACT

The invention relates to an optical detection system for detecting the optical distribution of a display device having a light source and a predetermined display range divided into multiple virtual detection regions. The system includes a power module for supplying power to the light source, a monochromatic module for detecting luminous intensity of the light source at various wavelengths within a selected virtual detection region, multiple optical sensor modules, each corresponding to one of the virtual detection regions, a memory module saving wavelength correction parameters of the optical sensor modules, and a processor module receiving the wavelength distribution within the selected virtual detection region of the display device, and for calculating and compensating for expected detection values of the respective optical sensor modules based on the wavelength correction parameters and actual detection values of the optical sensor modules.

### FIELD OF THE INVENTION

The present invention relates to an optical detection system and, more particularly, to an optical detection system for rapid and accurate detection of the optical imaging characteristics (chromaticity, brightness, luminance, etc.).

### DESCRIPTION OF THE RELATED ART

With the continued development of modern technology, and the higher demands of modern people towards life quality, more and more video devices have come into being. For example, the LED backlight LCD display or television has become an indispensible appliance to many families. Moreover, the projector with high-pressure discharge lamp, or portable LED projector takes another consumer group as the target. It is quite important for the users who need to transmit information through meetings, briefings or teaching sessions. Thus, the targets for this type mainly include companies, schools or governmental institutions. In addition, the home theater or projector also has its share in the market.

With huge market demands for display or projection devices, many operators invest large amounts of manpower and funds into technological research, which results in rapid improvement of imaging technology. However, with the mass production in factories, there are also increasing probabilities for defects caused by unexpected factors of human error and process error, such as non-uniform display brightness, saturation and other problems of optical characteristics, which hinder the assurance of product quality.

Therefore, there is a need for a complete and accurate detection system to detect the optical characteristics of these display devices. The system can measure the defects accurately and perform real-time calibration and management for the defective products, so as to improve overall quality of the production line. If the defective products with serious defects are delivered to the consumers or suppliers, it will result in refund trouble, and even affect the business reputation. Therefore, all manufacturers require a product inspection on the production line.

Aside from accurate detection, it also requires high detection speed since many manufacturers produce products in large quantities every day under the globalization trend. Consequently, either poor detection quality or slow detection speed will burden the operation of the production line, finally affecting the product delivery. In case of the above detection efficiency problems, it will not only affect the delivery time, but also decrease the market competitiveness of the products. Even if the product's functions are superior to its counterparts on the market, it will not be successful in the end.

In the current market, the optical characteristics detected for the display devices mainly include luminous brightness, luminance on display surface, and uniformity of brightness, chromaticity or color temperature. Among commonly used instruments, spectrometers are relatively accurate and are often used to detect luminance in different wavelengths to obtain complete spectrum information of the tested display device, so as to confirm the above optical characteristics. However, a spectrophotometer is fairly expensive and the test is time-consuming.

U.S. Pat. No. 6,614,518 disclosed a simpler instrument. As shown in FIG. 1, the conventional instrument adopts a conventional luminance meter 83 or a brightness meter. It does not perform measurement for a display device or projector 82 under different wavelengths, but only outputs an overall luminance receiving the luminance flux, or luminous intensity or luminance emitted or reflected in a certain direction over each unit region of the object. This structure takes advantage of the luminance meter and, therefore, has the advantages of fast detection and low price. However, it only provides a single measurement value, rather than performing measurement under respective wavelengths. Thus, it fails to reflect the optical characteristics of the display device or projector 82 correctly and completely.

As such, a combination of a single spectrophotometer with multiple luminance meters has been proposed, as shown in FIG. 2. Simply by moving a single spectrophotometer 81′, this system allows a single spectrophotometer 81′ to work with multiple luminance meters in turn, such as the nine luminance meters 83′ shown in FIG. 2, so as to obtain the luminous intensity information of respective regions on the large size display device 82′. Moreover, the system can calibrate the output value of the luminous meters 83′ through the wavelength distribution measured by the spectrophotometer 81′. However, due to the slow measurement speed of spectrophotometer 81′, and nine repeated measurements in total, it increases the overall measurement time. Therefore, it is commercially impractical.

On the other hand, as shown in FIG. 3, a system for inspecting large-size display panels was proposed, in which for each luminous meter 83″ is combined with a spectrophotometer 81″ to realize multi-point measurement. However, this structure increases the cost greatly and does not have market competitiveness.

Furthermore, R.O.C. Patent Application No. 098127865, entitled “Photometric/Colorimetric Device,” proposed a system shown in FIG. 4. It mainly applies a single spectrophotometer 81″′ to measure the light source of a display device 82″′ with known wavelength distribution. It also combines with the nearby sensors 83″′ for measuring tri-stimulus values (luminance meters or brightness meters) for calibration. After measuring the known light source, the empirical values obtained by the sensors were compared with the theoretical values, and the calibration coefficients of the tri-stimulus value sensor 83″′ under the known wavelength distribution were recorded. However, this calibration is only applicable to the uniform light source which has slight chromaticity difference of the luminance at each point. In case the great chromaticity difference exists in the luminance of the target light source, this calibration method will result in a significant error.

Put it simply, the luminance meters or brightness meters show individual differences in wavelength response. When the objects under test have different wavelength distributions, the calibration coefficient for each luminance meter or brightness meter should be adjusted dynamically. However, based on the existing technology, the entire system is simply calibrated against a known light source before delivery and a fixed calibration coefficient is recorded for each luminance meter or brightness meter with respect to the value measured against specific light source, by which all of the future light sources will be compensated for according to the fixed calibration coefficient during the test.

Consequently, for the light sources with poor white balance, such as those rich in red or blue, the conventional system will be interfered by the wavelength response difference of the individual luminance meters and the compensation error of the fixed calibration coefficients. As a result, the final measurement results will be inconsistent with the actual situation, and the operator of the system will obtain wrong results.

In order to address the limitations and shortcomings of the detection systems described above, an optical detection system is disclosed herein and it is shown to perform an improved measurement speed. Moreover, without increasing the costs highly, it could work with the detection method proposed herein to achieve an effect comparable with the multi-point calibration.

### SUMMARY OF THE INVENTION

The first aspect of the invention is directed to an optical detection system for accurate detection of the display characteristics of a display device.

The second aspect of the invention is directed to an optical detection system for dynamic compensation for the wavelength response differences among the respective optical detection modules, whereby the problem of non-ideal wavelength distribution of the light source is overcome and the detection quality of the display device is improved.

Yet, the third aspect of the invention is directed to an optical detection method for detection of the display characteristics of the display device.

To achieve the above objectives, the invention provides an optical detection system for detecting optical distribution of a display device. The display device comprises a light source and a predetermined display range divided into a plurality of virtual detection regions. The optical detection system comprises:

a power module for supplying power to the light source;

a monochromatic module for detecting luminous intensity of the light source at various wavelengths within a selected one of the virtual detection region;

a plurality of optical sensor modules, each corresponding to one of the virtual detection regions;

a memory module for saving wavelength correction parameters of the respective optical sensor modules; and

a processor module for receiving the wavelength distribution within the selected one of the virtual detection regions of the display device as detected by the monochromatic module, and for calculating and compensating for expected detection values of the respective optical sensor modules based on the wavelength correction parameters and actual detection values of the respective optical sensor modules.

The invention further provides an optical detection method for detecting optical characteristics of a display device using an optical detection system. The display device comprises a light source and a predetermined display range divided into a plurality of virtual detection regions. The optical detection system comprises a monochromatic module for performing detection on a selected one of the virtual detection regions and a plurality of optical sensor modules, each corresponding to one of the virtual detection regions, and wherein the optical sensor modules obtain wavelength correction parameters for the respective virtual detection regions which are in turn saved in a memory module. The optical detection method comprises the steps of:
a) supplying power to light up the light source;
b) using the monochromatic module to detect the luminous intensity at various wavelengths within the selected one of the virtual detection regions; and
c) calculating compensation coefficients for the respective optical sensor modules based on the luminous intensity distribution obtained by the monochromatic module and the wavelength correction parameters of the optical sensor modules, and compensating for and outputting the detected values measured by the optical sensor modules.

To sum up, this invention overcomes the problems existing in the art by providing the optical detection system and the detection method using the system as disclosed herein. It can not only accurately compensate for the wavelength response difference among the respective optical sensor modules and make the measured data consistent with the actual situation, but also finish the detection efficiently and reduce the industrial production costs. Moreover, it can guarantee that the imaging quality of the display device could be measured correctly. In this way, the display device after delivery can present perfect luminous intensity or imaging chromaticity in each region, achieving all the objectives sought for by the invention.

### BRIEF DESCRIPTION OF THE DRAWINGS

FIG. 1 is a schematic diagram of a known optical detection system;

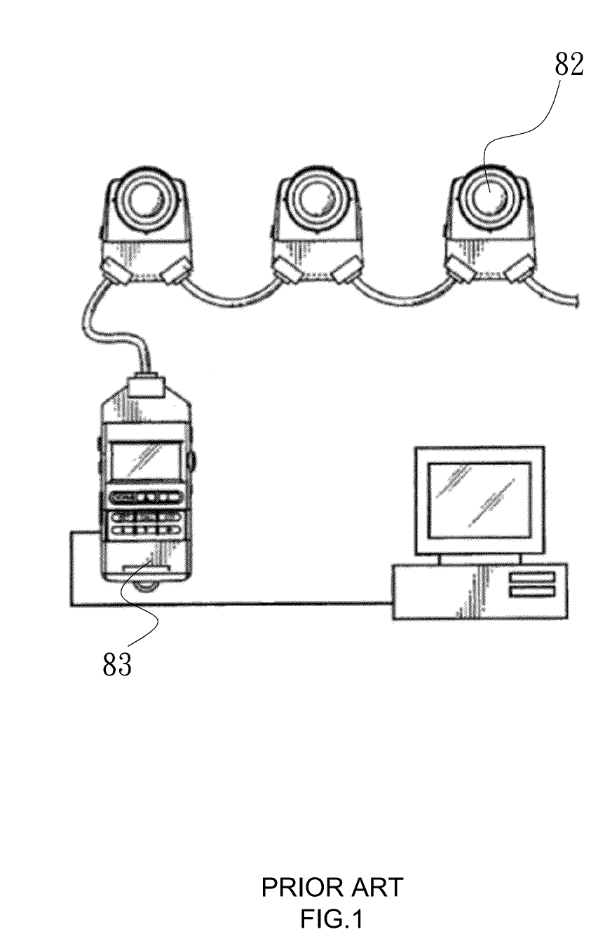

FIG. 2 is a schematic diagram of another known optical detection system;

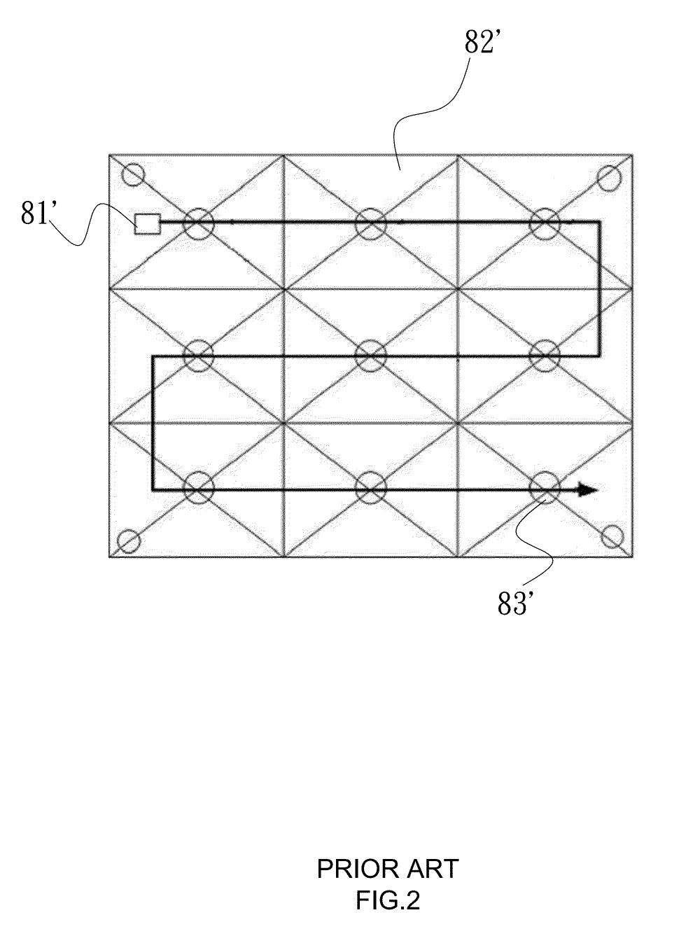

FIG. 3 is a schematic diagram of still another known optical detection system;

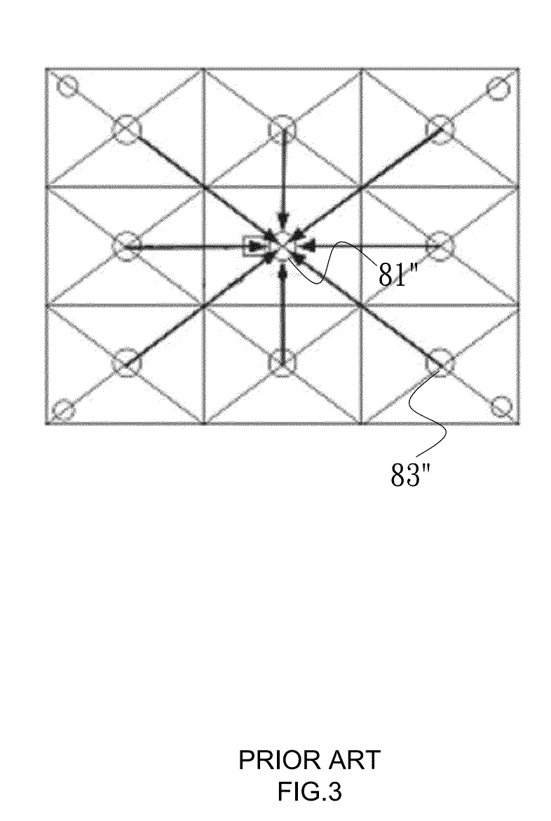

FIG. 4 is a schematic diagram of still another optical detection system;

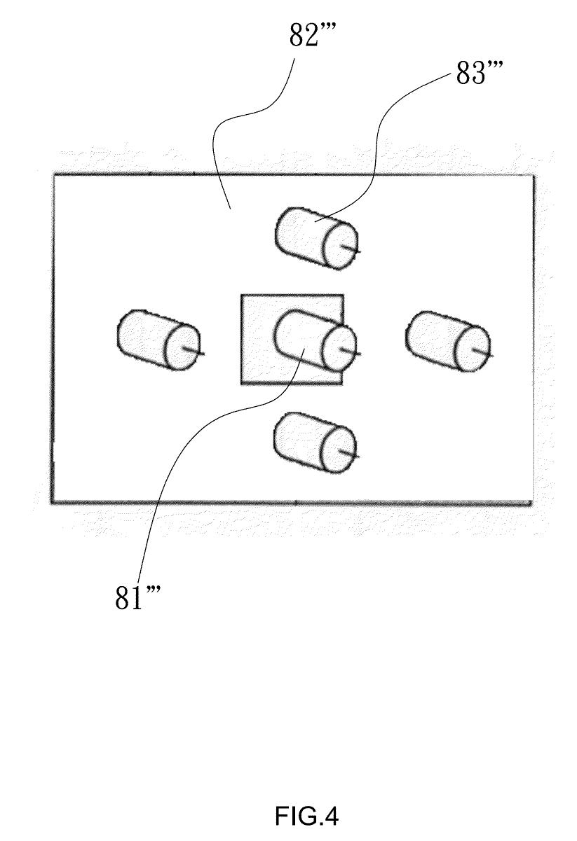

FIG. 5 is a block diagram of the first preferred embodiment of this invention;

FIG. 6 is the schematic top diagram of the embodiment shown in FIG. 5, showing the relationship between the display device under test and the optical detection system disclosed herein; and

FIG. 7 is a flowchart of the optical detection method using the optical detection system shown in FIG. 5.

### DETAILED DESCRIPTION OF THE PREFERRED EMBODIMENTS

The aforementioned and other technical contents, aspects and effects in relation with the invention can be clearly appreciated through the detailed descriptions concerning the preferred embodiments of the invention in conjunction with the appended drawings.

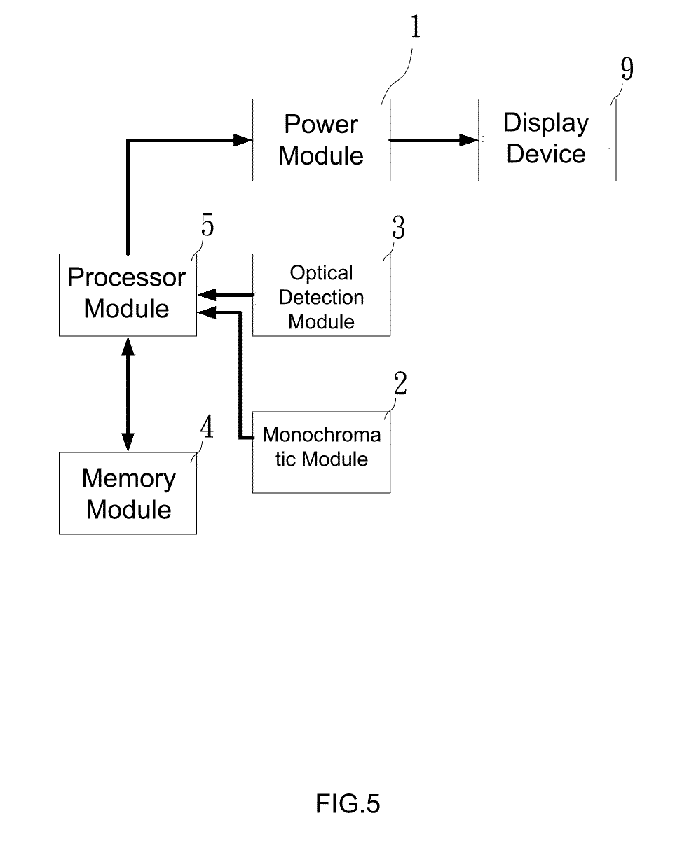

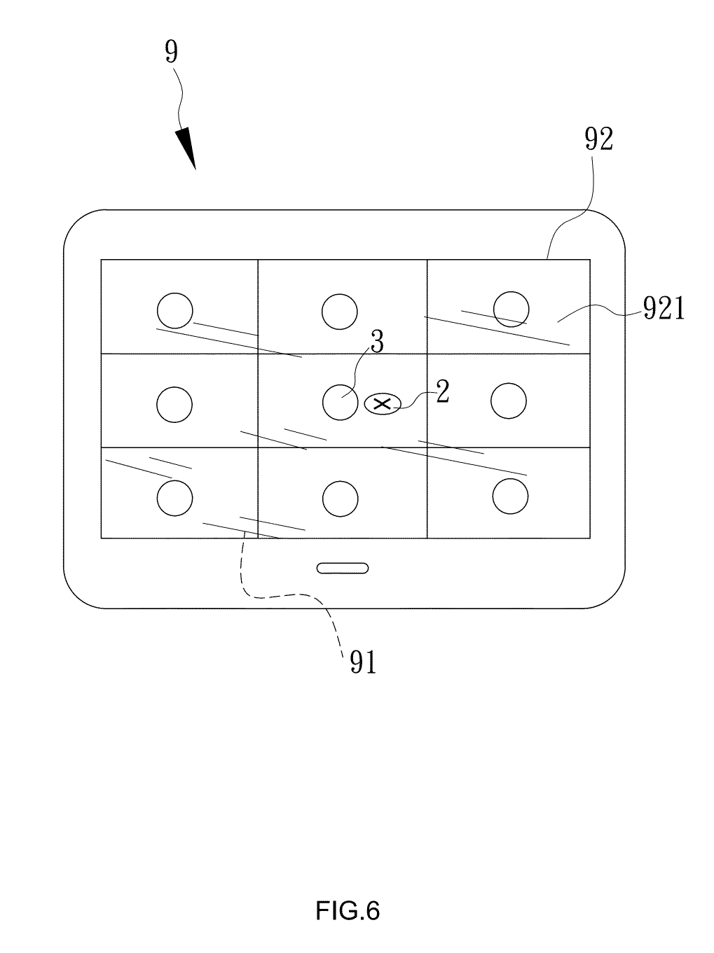

FIGS. 5 and 6 are schematic diagrams of an optical detection system disclosed in the invention. For the purpose of illustration, the system is used to detect the luminous intensity or reflex intensity of a display device 9. Put it simply, it is to detect the optical characteristics of light source 91 of the display device 9, including brightness, luminance, chromaticity and so on. In this way, the complete optical display information of the display device 9 can be detected. The display device 9 described herein is intended to encompass all types of display panels and projection devices known in the art.

The display device 9 includes a light source 91 and a predetermined display range 92. The predetermined display scope 92 is illustrated as a rectangular image zone, but the actual application is not limited to such. The light source 91 can by way of example be a projector light source or a LED light source. For convenience of explanation, the predetermined display range 92 of the display device 9 is divided into 9 blocks, which stands for virtual detection regions 921, however, they do not exist actually.

For example, the display device 9 is a LCD display device provided with a LED backlight. Large-size backlights are typically provided with a large number of direct-lit LEDs or LED bars as the light source. The respective backlights may only differ slightly from one another in terms of luminous color, but will have greater difference in luminous efficiency. Thus, they must be tested for optical display characteristics (including chromaticity, brightness, etc.) before release to the market. The optical detection system disclosed herein is applicable to measure the luminous brightness or chromaticity of the respective virtual display regions of the display device 9, based on which it will determine the display quality and even further modulate the driving current of the respective virtual display regions to make the luminance uniform.

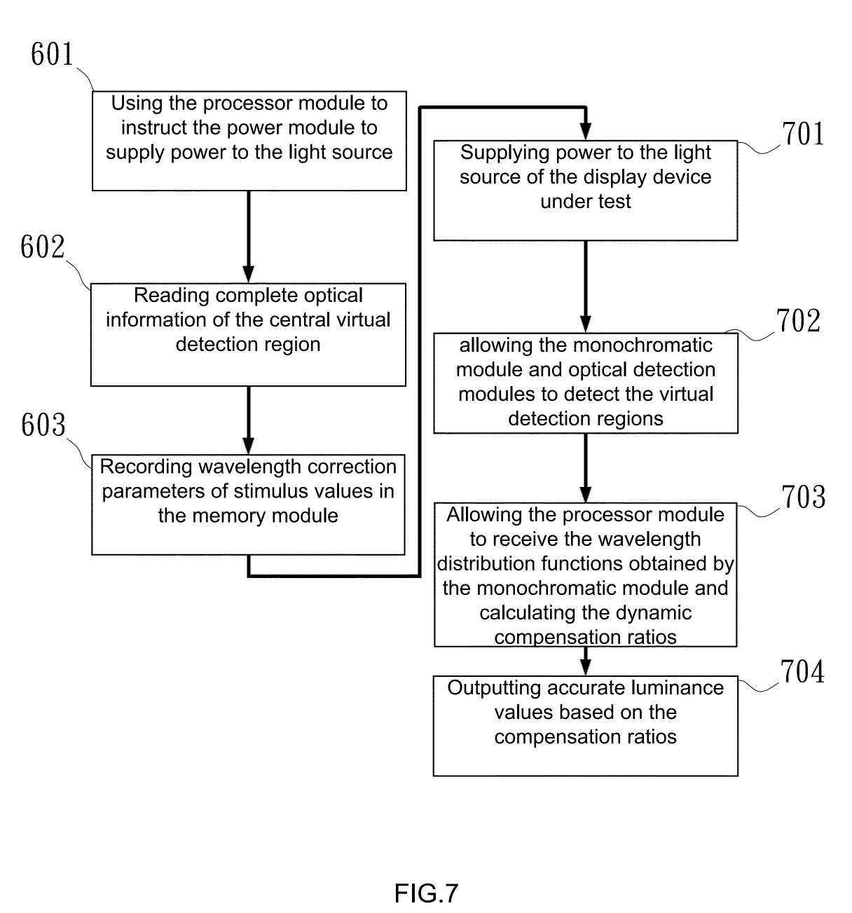

The main structure of the optical detection system according to the invention is shown in FIG. 5, comprising: a power module 1, a monochromatic module 2, optical sensor modules 3, a memory module 4, and a processor module 5. As shown in FIG. 6, when the detection system is tested in the factory, each virtual detection region 921 of the display device 9 will be made correspond to an optical sensor module 3, so that the imaging characteristics of the respective virtual detection regions 921 are detected. This application adopts nine virtual detection regions 921, and takes luminance meters as the optical sensor modules 3. The virtual detection region 921 located at the center is further equipped with a monochromatic module 2, which may by way of example be a spectrometer, so as to obtain the complete optical information within the detection range of the luminance meter located at the center. The flowchart in FIG. 7 shows the calibration of the detection system before delivery from the factory and the detection method performed after the delivery.

In Step 601, the processor module 5 initially instructs the power module 1 to supply power to the light source 91 of the display device 9. Next, in Step 602, the monochromatic module 2 corresponding to the virtual detection region 921 located at the center reads the complete optical information of the virtual detection region 921 located at the center, which is represented by P_{LED}(λ). An equation is provided below:

Xₙ=∫P_{LEDs}(λ)X(λ)dλ=k_{LED}∫P_{LEDs}(λ)Dn(λ)dλ,

wherein P_{LEDs}(λ) represents the wavelength distribution function curve of light emitted from the LED light source onto the central region as measured by the monochromatic module 2, while Xₙ represents the theoretical stimulus value received by the luminance meter n. For the purpose of illustration, we take the stimulus value of red light as an example, and the theorem is the same for the green light and blue light. Dn(λ) represents the wavelength response of the luminance meter. The luminous efficiency function X(λ) is known. Thus, after the monochromatic module 2 resolves the wavelength distribution function on the left side of the equation above, the actual luminance value measured by the luminance meter n, namely, ∫P_{LEDs} (λ)Dn(λ) dλ on the right side of the above equation, is compared with the theoretical value Xₙ on the left side, so as to obtain the wavelength correction parameter of the luminance meter, k_{LED}, which can be also represented by a function. By using the same wavelength distribution function of the light source, the wavelength correction parameter of the red stimulus-value for each luminance meter, k_{nX}, can be obtained. The wavelength correction parameters of green and blue stimulus-values, k_{nY} and k_{nZ} can be calculated in a similar manner. All these parameters will be recorded in the memory module 4 in Step 603.

After delivery from the factory, the optical detection system according to the invention is adapted for performing detection. As indicated in Step 701, the system supplies power to the light source 91 of a display device 9. In step 702, the monochromatic module 2 and the optical sensor modules 3 detect the respective virtual detection regions 921 of the display device 9. Then, in Step 703, the processor module 5 receives the wavelength distribution function of light emitted from the light source 91 of the display device 9 as measured by the monochromatic module 2. Based on the wavelength correction parameters for the respective optical sensor modules 3, a dynamic compensation ratio is calculated. Finally, in Step 704, the luminance values detected by the respective optical sensor modules 3 are subjected to calculation based on the compensation ratio to give and output the corrected luminance values.

The invented method only performs a complete measurement on the light source located at the center, but from there the wavelength correction parameters for the stimulus values of the other light source regions can be deduced. It has been empirically shown that the deduced results were quite similar to those obtained by performing actual measurement on the respective light sources and were far accurate than those achieved by the methods known in the art. The method disclosed herein has high feasibility and the optical detection system disclosed herein is easy-to-use and high throughput. The invention is applicable to product inspection in factory and real-time monitoring of the production line.

Therefore, The optical sensor modules 3 are employed to obtain the tri-stimulus values of the display device 9 under its full-bright state and the weighted ratios among the red, green and blue lights emitted from the display device 9 are adjusted using the optical detection system and method disclosed herein, thereby obtaining the accurate tri-stimulus values. For making the display device have uniform light emission or compensating for its light decay, the invention can provide accurate stimulus values to facilitate the precision of the subsequent calibration. Compared with the prior art, the optical detection system and method disclosed herein can achieve accurate measurement of chromaticity and brightness without the aid of an expensive and complicated optical detection system and can achieve high throughput and high optical detection accuracy.

Of course, it is apparent to those skilled in the art that the optical sensor module described above is not limited to a luminance meter and the invention can be practiced by alternatively using a brightness meter, a single-point color analyzer, a 2D-imaging color analyzer or other optical instruments to perform optical calibration. Therefore, the invention increases the selection flexibility for detection.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. An optical detection system for detecting optical distribution of a display device comprising a light source and a predetermined display range divided into a plurality of virtual detection regions, the optical detection system comprising:
a power module for supplying power to the light source;
a monochromatic module for detecting luminous intensity of the light source at various wavelengths within a selected one of the virtual detection region;
a plurality of optical sensor modules, each corresponding to one of the virtual detection regions;
a memory module for saving wavelength correction parameters of the respective optical sensor modules; and
a processor module for receiving the wavelength distribution within the selected one of the virtual detection regions of the display device as detected by the monochromatic module, and for calculating and compensating for expected detection values of the respective optical sensor modules based on the wavelength correction parameters and actual detection values of the respective optical sensor modules.

2. The optical detection system according to claim 1, wherein the monochromatic module is a spectrophotometer.

3. The optical detection system according to claim 1, wherein each of the optical sensor modules is a luminance meter for measuring a density of luminance flux received by the corresponding one of the virtual detection regions.

4. The optical detection system according to claim 1, wherein the optical sensor module is a brightness meter for measuring the brightness difference within the corresponding one of the virtual detection regions.

5. The optical detection system according to claim 1, wherein each of the optical sensor modules is a single-point color analyzer for measuring chromaticity, luminance, and color temperature within the corresponding one of the virtual detection regions.

6. The optical detection system according to claim 1, wherein each of the optical sensor modules is an 2D-imaging color analyzer for measuring chromaticity, luminance, and color temperature within the corresponding one of the virtual detection regions.

7. An optical detection method for detecting optical characteristics of a display device using an optical detection system, wherein the display device comprises a light source and a predetermined display range divided into a plurality of virtual detection regions, and the optical detection system comprises a monochromatic module for performing detection on a selected one of the virtual detection regions and a plurality of optical sensor modules, each corresponding to one of the virtual detection regions, and wherein the optical sensor modules obtain wavelength correction parameters for the respective virtual detection regions which are in turn saved in a memory module, the optical detection method comprising the steps of:
a) supplying power to light up the light source;
b) using the monochromatic module to detect the luminous intensity at various wavelengths within the selected one of the virtual detection regions; and
c) calculating compensation coefficients for the respective optical sensor modules based on the luminous intensity distribution obtained by the monochromatic module and the wavelength correction parameters of the optical sensor modules, and compensating for and outputting the detected values measured by the optical sensor modules.
